(19) United States
(12) Patent Application Publication
(10) Pub. No.: US 2006/0183435 A1
(43) Pub. Date: Aug. 17, 2006

(54) Keyboard structure

(75) Inventor: Chun-Lin Chen, Taipei Hsien (TW)

Correspondence Address: BIRCH STEWART KOLASCH & BIRCH, PO BOX 747, FALLS CHURCH, VA, 22040-0747, US

(73) Assignee: Chicony Electronics Co., Ltd.

(21) Appl. No.: 11/056,602

(22) Filed: Feb. 14, 2005

(51) Int. Cl. H04B 1/38; H04M 1/00

(52) U.S. Cl. 455/90.3; 455/575.3; 455/575.1

(57) ABSTRACT

A keyboard structure has a housing with a first cover and a second cover. A plurality of keys is provided on the first cover and used for data input. A wireless transmission module is located inside the housing for transmitting signals. A first clamping part pivoted on the second cover and a second clamping part is pivoted on the first clamping part. By means of the bluetooth technology used for data transmission and work together with a mobile phone or a PDA, data is conveniently input, and further the first clamping part and the second clamping part work together to clamp the mobile phone and the PDA so that a user may hold the device in hand to input data.

### BACKGROUND OF THE INVENTION

1. Field of the Invention

This invention relates to a keyboard structure and particularly to one embedded with a bluetooth module for communication with a mobile phone or a Personal Digital Assistant (PDA) for a facility of data input.

2. Description of Related Art

Conventionally, a mobile phone, a PDA, or the like is designed to be portable, tiny, light, and thin; however, in order to minimize the volume of mobile phone or PDA, the facility of input into the mobile phone or PDA must be neglected. For example, a touch pen is used as an input tool of the conventional PDA, while multiple keys are used as the tool of the conventional mobile phone. However, extensive data input into a mobile phone or PDA is extremely inconvenient, and thus an external keyboard serves as a very important input assistant. A general keyboard, however, is connected through an adapter, only, without another upholder and may fall off or permit slight shaking to interrupt signals, so the external keyboard is used on a stable surface, only, and cannot be manually operated outdoors or in a car.

The above-mentioned external keyboard structure is connected to PDA, mobile phone, or any kind of hand-held device for proper collection or driving the whole keyboard body through wired or wireless signal, and the keyboard, after being opened, forms an enough space for a PDA, mobile phone, or any kind of hand-held device.

Referring now to FIG. 1, in order to achieve the object mentioned above, the external keyboard structure mainly comprises a foldable seat 10 and an adjusting device 20 mounted on the foldable seat 10 and assembled together with a keyboard 30 and an allowing area 11 for PDA, mobile phone, or any kind of hand-held device is formed between the foldable seat 10 and the keyboard 30. By means of the assembly of structure, when the structure is used, a zone of the foldable seat 10 is outwardly unfolded to be flatly placed and the keyboard 30 is moved upwardly onto the other zone of the foldable seat 10 through the adjusting device 20 so that a PDA, mobile phone, or any kind of hand-held device is placed in the allowing area 11. If the structure, after use, is folded to collect the keyboard 30, the adjusting device 20 is used to drive the keyboard 30 to parallel-shift to the zone of the foldable seat 10 in the opposite direction for concealment of the allowing area. Finally, the two zones of the foldable seat 10 are mutually overlapped for portability and collection capability.

Although the above-mentioned external keyboard structure may effectively solve the problem of dropping or signal interruption of the conventional keyboard structure connected to the used mobile device through only an adapter, its components are complicated and not easily assembled, relatively increasing manufacturing cost.

### SUMMARY OF THE INVENTION

This invention provides a keyboard structure and particularly to a keyboard using a bluetooth technology to transmit data, communicating with a mobile phone or a Personal Digital Assistant (PDA) for facility of data input.

Additionally, this invention provides a keyboard structure and in particular clips to the mobile phone or the PDA for manual data input.

In order to achieve the object mentioned above, this invention provides a keyboard structure comprising the following elements. A housing has a first cover and a second cover. A plurality of keys is used for data input and is located on the first cover. A wireless transmission module is used for signal transmission and is located inside the housing. A first clamping part is pivoted on the second cover, while a second clamping part is pivoted on the first clamping part.

In order to further explain the features and technical means of this invention, reference is made to the detailed description according to this invention and the accompanying drawings. However, the accompanying drawings are provided for reference and illustration only and are not limited to this invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a 3D exploded view of a conventional external keyboard;

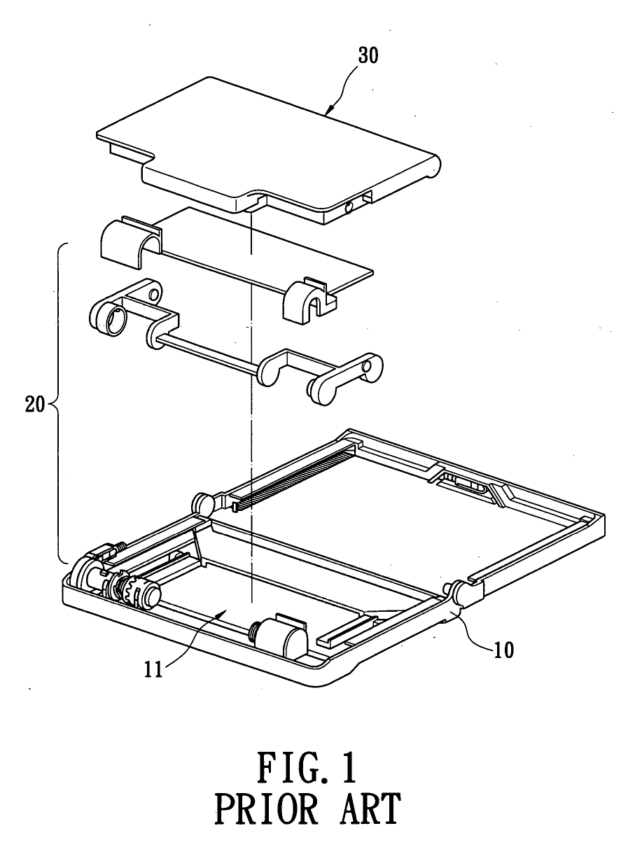

FIG. 2 is a 3D exploded view of a preferred embodiment of a keyboard structure according to this invention;

FIG. 3 is a 3D assembly view of the preferred embodiment of the keyboard structure according to this invention;

FIG. 4 is a side view of the preferred embodiment of the keyboard structure according to this invention;

FIG. 5 is a view of the movement of a first clamping part and a second clamping part of the preferred embodiment of the keyboard structure according to this invention;

FIG. 6 is a reference view of a service condition of the preferred embodiment of the keyboard structure according to this invention;

FIG. 7 is a schematic view illustrating a further cooperation of the preferred embodiment of the keyboard structure according to this invention with a holding unit;

FIG. 8 is a reference view of a service condition of the preferred embodiment of the keyboard structure according to this invention matching with the holding unit; and

FIG. 9 is a reference view of a service condition of the preferred embodiment of the keyboard structure according to this invention matching with another holding unit.

### DETAILED DESCRIPTION OF THE PREFERRED EMBODIMENTS

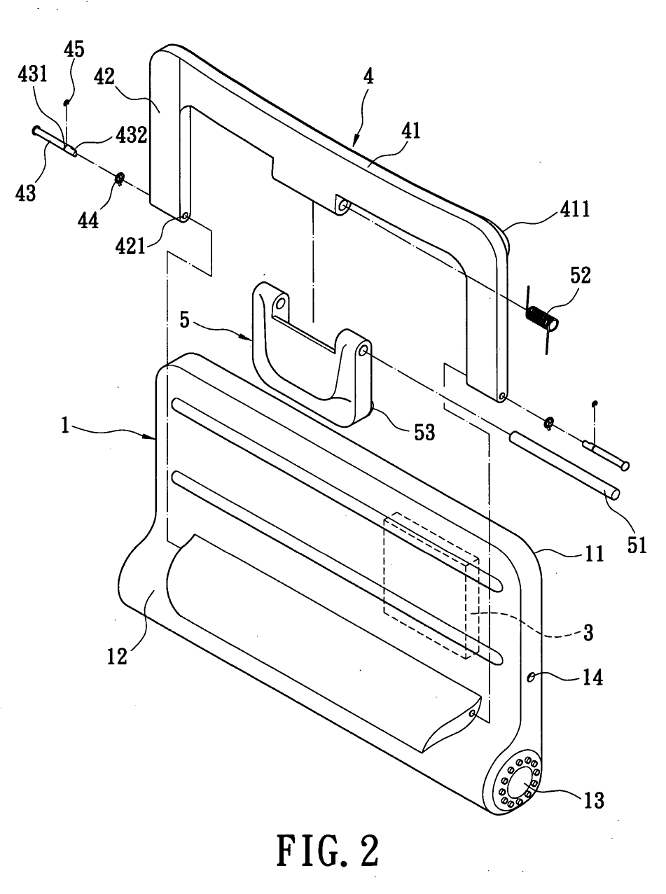

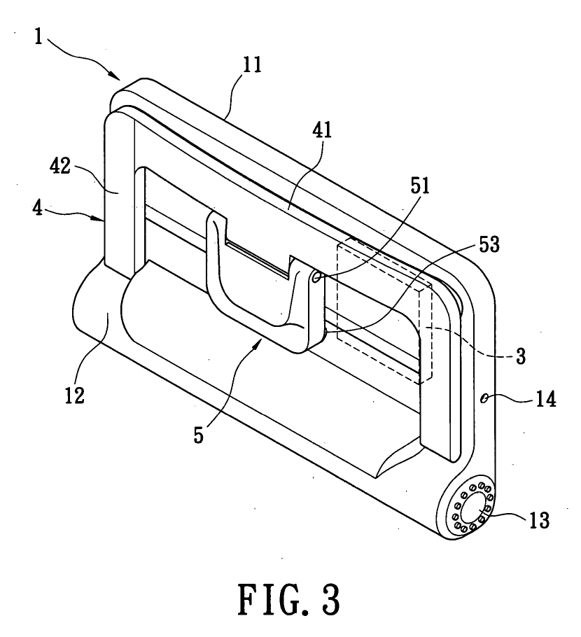

Referring now to FIGS. 2 to 5, this invention provides a keyboard structure comprising a housing 1, a plurality of keys 2, a bluetooth module 3, a first clamping part 4, and a second clamping part 5.

The housing 1 has a first cover 11 and a second cover 12. The first cover 11 serves as a front cover of the housing 1, while the second cover 12 serves as a back cover of the housing 1. The margin of a side of the housing 1 is provided with a battery lid 13 to cover a battery or batteries in the housing, while the margins of two sides of the housing are respectively provided with a concavity 14.

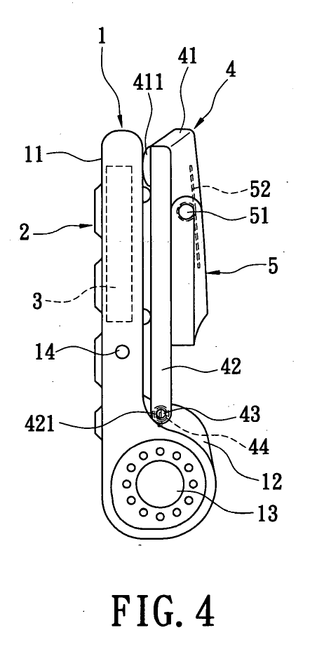

The keys 2 are provided on the first cover 11 (as shown in FIG. 4), allowing a user to input data conveniently. The bluetooth module 3 is provided in the housing 1 so as to transmit signals, transmitting data input by the user using the keys 2 on the keyboard to a mobile phone or a PDA by means of wireless transmission technology.

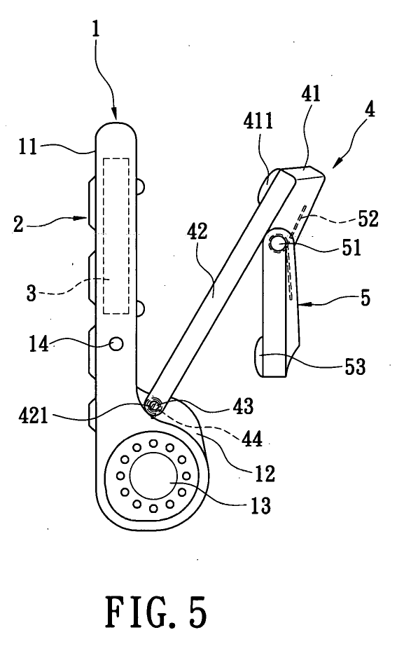

The first clamping part 4 is pivoted onto the second cover 12 and provided with a holding unit 41 of which a side is provided with a first non-slip unit 411 made of a rubber material and kept close to the second cover 12. Two sides of the holding unit 41 are respectively bent to extend arms 42 and a side of each arm 42 is provided with a through hole 421, each of which is pivoted onto the second cover with a first bolt 43. The first clamping part 4 and the second cover 12 may thereby move back and forth with respect to each other, as shown in FIG. 5. The first bolt 43 is provided with a wedging portion 431 and a fitting side 432. A first spring 44 and a retaining ring 45 are provided on the first bolt 43, the first spring 44 is fitted to the fitting side 432 of the first bolt 43, the retaining ring 45 is a C-shaped ring wedged onto the wedging portion 431 of the first bolt 43, and the first spring 44 is spiraled, giving elasticity to the first clamping part 4 to clamp a mobile device (a mobile phone or a PDA) fitted to the structure according to this invention.

The second clamping part 5 is pivoted on the first clamping part 4, of which the margin of a side is provided with a second non-slip unit 53 made of a rubber material. The second non-slip unit 53 keeps close to the second cover 12. The second clamping part 5 is pivoted with a second bolt 51 to a side of the holding unit 41, so the second bolt 51 serves as a revolving spindle between the first clamping part 4 and the second clamping part 5. The second clamping part 5 and the first clamping part 4 may thereby move back and forth with respect to each other, as shown in FIG. 5. A second spring 52 is provided on the second bolt 51, and serves as a torsion spring giving elasticity to the second clamping part 5 to clamp the mobile device (the mobile phone or PDA) fitted to the structure according to this invention.

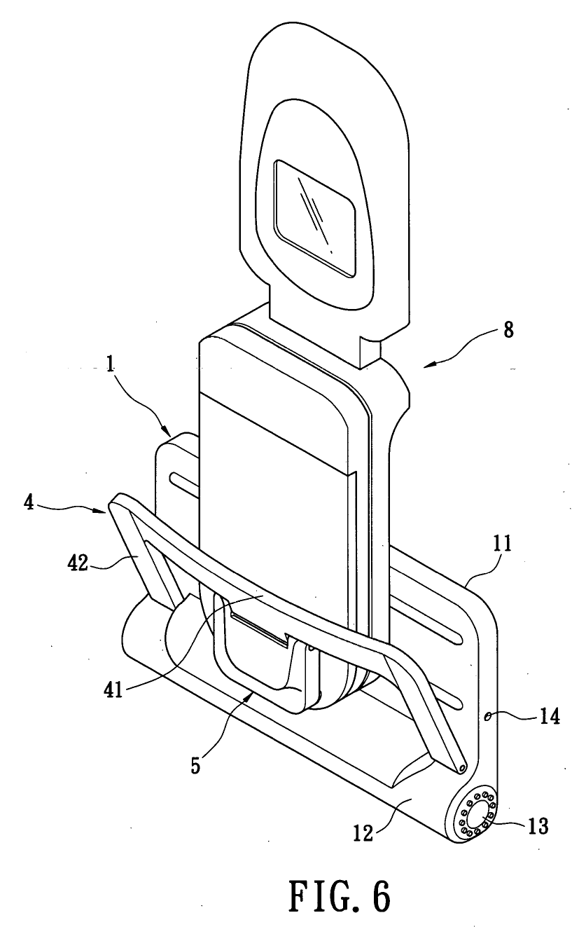

FIG. 6 is a reference view of a service condition of the preferred embodiment of the keyboard structure according to this invention. In the figure, the first clamping part 4 and the second clamping part 5 work together to clamp a mobile phone 8. The first clamping part 4 gives a clamping force to the mobile phone 8 through the revolving spring, while the second clamping part 5 gives another clamping force to the mobile phone 8 through the torsion spring to firm hold the mobile phone 8.

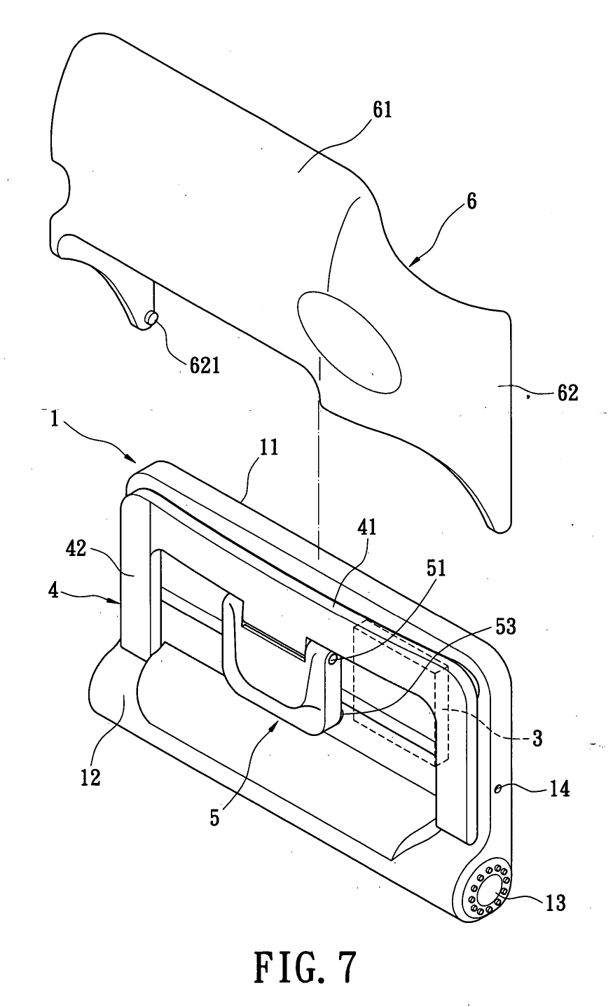

FIG. 7 is a schematic view illustrating a further co-operation of the preferred embodiment of the keyboard structure according to this invention with a holding unit. The structure according to this invention further comprises a supporting unit 6 to support a mobile device, such as the mobile phone, the PDA and the like. The supporting unit 6 is located on the housing 1 wedged to the supporting unit 6 with their guiding convexes and concaves. Two sides of the supporting component 61 are respectively formed with a holding arm 62, of which the margin of an inner side is provided with a convex 621, and two sides of the housing 1 are respectively provided with a concavity 14 so that each holding arm 62 is fixed to a side of the housing 1 with both the guiding convex 621 and the concavity 14 mutually wedged together.

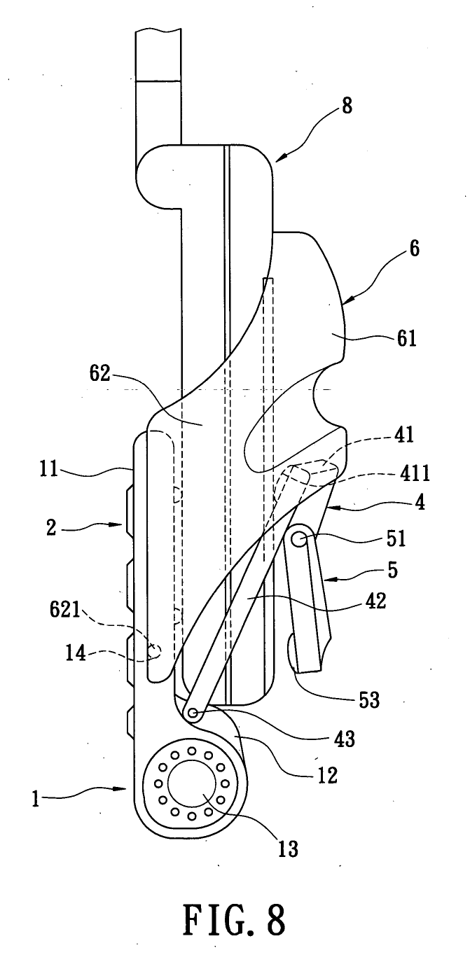

FIG. 8 is a reference view of a service condition of the preferred embodiment of the keyboard structure according to this invention matching with a holding unit. In the figure, the first clamping part 4 and the second clamping part 5 work together to clamp the mobile phone 8. The structure according to this invention also uses the supporting unit 6 to support the mobile phone 8, and the supporting component 61 of supporting unit 6 is used to firmly support the back of mobile phone 8 so that the user may hold the phone 8 by hands to input data. The holding arms 62 of the two sides of the supporting unit 6 are fixed onto the housing with both the guiding convexes 621 and the concavities 14 of the two sides of the housing mutually wedged together.

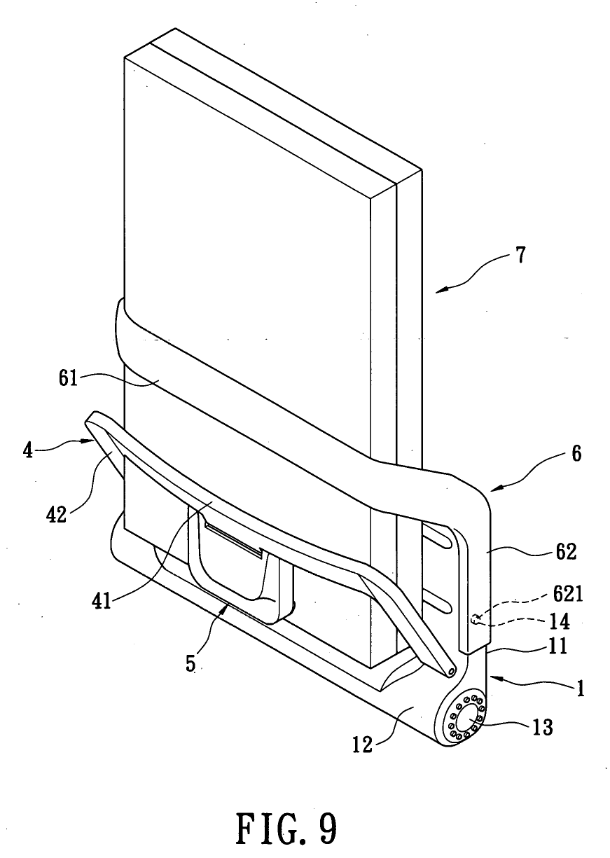

FIG. 9 is a reference view of a service condition of the preferred embodiment of the keyboard structure according to this invention matching with another holding unit. In the figure, the first clamping part 4 and the second clamping part 5 work together to clamp the PDA 7, the supporting unit 6 may also be used to support the PDA 7. The supporting unit 6 is installed on the housing 1 and the supporting component 61 of supporting unit is used to support firmly the back of PDA so that the user may hold the PDA by hands to input data. The holding arms of the two sides of the supporting unit 6 is fixed onto the housing 1 with both the guiding convexes 621 and the concavities 14 of the two sides of the housing 1 mutually wedged together. Characteristics are given from the keyboard structure according to this invention in conclusion:
1. This invention is a keyboard structure with bluetooth technology, of which the first clamping part 4 and the second clamping part 5 are provided to work together to clamp the mobile device (the mobile phone and the PDA), not only allowing the user to hold by hands to input data conveniently, but also simplifying structural components. Only the first clamping part 4 and the second clamping part work together to hold easily the mobile device matching with this invention. Requirements for user-friendliness and convenient operation for the user want are met, and in the aspect of manufacturing, thanks to few components required, easy assembly is achieved so yields may be increased and production costs may be decreased.
   The supporting unit 6 according to this invention is used to support the mobile device (the mobile phone and the PDA), installed in the housing 1, and is provided with a supporting component 61 used to support the back of mobile device, achieving firm support of the mobile device so a user may hold the device in hand to input data.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A keyboard structure, comprising:
a housing provided with a first cover and a second cover;
a plurality of keys provided on the first cover and used for data input;
a first clamping part pivoted on the second cover; and
a second clamping part pivoted on the first clamping part.

2. The keyboard structure according to claim 1, wherein a battery lid is provided on the housing.

3. The keyboard structure according to claim 1, the first clamping part is being provided with a holding unit, wherein two sides of the holding unit are respectively bent to extend arms, and each arm is provided with a through hole and pivoted onto the second cover with a first bolt.

4. The keyboard structure according to claim 3, wherein a first spring is provided on the first bolt.

5. The keyboard structure according to claim 4, wherein the first spring is spiral.

6. The keyboard structure according to claim 3, wherein the holding unit is provided with a first non-slip unit and kept close to the second cover.

7. The keyboard structure according to claim 3, wherein the second clamping part is pivoted with a second bolt to a side of the holding unit.

8. The keyboard structure according to claim 7, wherein the second clamping part is provided with a second non-slip unit and kept close to the second cover.

9. The keyboard structure according to claim 7, wherein a second spring is provided on the second bolt.

10. The keyboard structure according to claim 9, wherein the second spring is a torsion spring.

11. The keyboard structure according to claim 1, further comprising a supporting unit located on the housing and wedged to the supporting unit with guiding convexes and concaves thereof.

12. The keyboard structure according to claim 11, the supporting unit is being provided with a supporting component, wherein two sides thereof are respectively formed with a holding arm, a margin of an inner side is provided with a convex, and two sides of the housing are respectively provided with a concavity, each holding arm being fixed to a side of the housing with both the guiding convex and the concavity mutually wedged together.

13. The keyboard structure according to claim 1, further comprising a wireless transmission module located inside the housing for transmitting signals.

14. The keyboard structure according to claim 13, wherein the wireless transmission module is a bluetooth module.
